(19) United States
(12) Patent Application Publication
(10) Pub. No.: US 2018/0314001 A1
(43) Pub. Date: Nov. 1, 2018

(54) ILLUMINATION ASSEMBLY PROVIDING BACKLIGHT AND DOWNLIGHT

(71) Applicant: Innotec, Corp., Zeeland, MI (US)

(72) Inventors: Thomas J. Veenstra, Lakewood, CO (US); Justin P. Boetsma, Zeeland, MI (US); Jason R. Mulder, Zeeland, MI (US)

(21) Appl. No.: 15/773,038

(22) PCT Filed: Nov. 3, 2015
(86) PCT No.: PCT/US15/58792

§ 371 Date: May 2, 2018

(51) Int. Cl. F21V 8/00; G09F 13/04; G09F 13/18

(52) U.S. Cl. CPC G02B 6/0088; G02B 6/0038; G02B 6/0085; G02B 6/0031; G09F 13/0409; G09F 2013/1881; G09F 13/18; G09F 13/0413; G09F 2013/049; G09F 2013/1804; G09F 13/04

(57) ABSTRACT

An illumination assembly includes a light pipe and a light engine. The light pipe has a first edge portion including a light inlet, a first surface including a first light outlet, and a second edge portion including a second light outlet. The light engine is attached to the first edge portion and includes a light source adapted to direct light into the light inlet, whereby light subsequently exits the light pipe through the first light outlet and the second light outlet. The illumination assembly can be used as part of an illuminated sign assembly to provide backlighting and downlighting.

### BACKGROUND OF THE INVENTION

The present invention relates to illumination assemblies, and more particularly to illumination assemblies for use in illuminating signs.

Illuminated signs often include a light source to backlight a sign face. Downlighting assemblies can include one or more light sources for illuminating an area below the sign. Sometimes illuminated signs and downlighting assemblies are used together in a common location. One example would be near a building exit, where an illuminated “EXIT” sign identifies the building exit and a separate downlighting assembly illuminates the building exit. Such combination lighting can be costly to purchase, install, and maintain due to the multiple lighting assemblies, light sources, connections, and wiring. Further, the dual assemblies can waste energy and light, which can be undesirable especially, in environments in which energy resources are costly or limited.

Shelf lighting and advertising are additional areas that present lighting challenges. Inadequately lit shelving can make it difficult to identify items on the shelf or read advertising or product information. In addition, it is often desirable for retailers and brands to use signs to identify the shelf where their products are stored in a way that draws attention. However, there is typically limited space on any given shelf for providing lighting for area illumination and identification and advertising purposes.

### SUMMARY OF THE INVENTION

The aforementioned problems are overcome in the present invention in which an illumination assembly includes a light pipe to provide both backlighting and area lighting simply, efficiently, and economically.

According to one embodiment, an illumination assembly includes (1) a light pipe including a first edge portion including a light inlet, a first surface including a first light outlet, and a second edge portion including a second light outlet and (2) a light engine attached to the first edge portion and including a light source adapted to direct light into the light inlet, whereby light subsequently exits the light pipe through the first light outlet and the second light outlet.

In another embodiment, an illumination assembly includes (1) a light pipe having a first surface and at least first and second edge portions and (2) a light engine on the first edge portion of the light pipe and having a light source configured to emit light into the first edge portion of the light pipe, wherein the light pipe is configured such that a first portion of the light exits through the first surface of the light pipe and a second portion of the light exits the light pipe through the second edge portion.

In yet another embodiment, an illuminated sign assembly includes (1) a first sign comprising a graphic, (2) a light pipe having a first surface aligned with the first sign and at least first and second edges, and (3) a light engine on the first edge of the light pipe and having a light source configured to emit light into the first edge of the light pipe, wherein the light pipe is configured to alter a direction of travel of at least a first portion of the light emitted by the light engine to backlight the graphic and a second portion of the light is emitted through the second edge to illuminate an area adjacent the second edge.

In another embodiment, an illumination assembly includes (1) a first light pipe including a first edge portion including a light inlet, a first surface including a first light outlet, and a second edge portion including a second light outlet, (2) a second light pipe including a third edge portion including a light inlet, a second surface including a third light outlet, and a fourth edge portion including a fourth light outlet, and (3) at least one light engine attached to the first edge portion of the first light pipe and the third edge portion of the second light pipe and including at least one light source adapted to direct light into the respective light inlets, whereby light subsequently exits the first light pipe through the first and second light outlets and exits the second light pipe through the third and fourth light outlets.

These and other advantages and features of the invention will be more fully understood and appreciated by reference to the description of the current embodiments and the drawings.

### BRIEF DESCRIPTION OF THE DRAWINGS

FIG. 1 is a perspective view of an illuminated sign assembly according to a first embodiment of the invention.

FIG. 2 is a perspective exploded view of the illuminated sign assembly of FIG. 1.

FIG. 3A is a perspective view of an illuminated sign assembly according to a second embodiment of the invention.

FIG. 3B is a schematic cross-sectional view of an illuminated sign assembly according to a third embodiment of the invention.

FIG. 4 is a perspective view of the illumination assembly in the illuminated sign assemblies of FIGS. 1 through 3.

FIG. 5A is a schematic cross-sectional view taken along line V in FIG. 4 of the illumination assembly having a first exemplary type of optical aberration.

FIG. 5B is a schematic cross-sectional view taken along line V in FIG. 4 of the illumination assembly having a second exemplary type of optical aberration.

FIG. 5C is a schematic cross-sectional view of an alternative light guide for use with the illumination assembly of FIG. 4.

FIG. 6 is a bottom view of the light engine of the illumination assembly.

FIG. 7 is an illustration of a use of the illuminated sign assembly.

FIG. 8 is a perspective view of an illumination assembly according to a fourth embodiment of the invention.

FIG. 9 is a bottom down view of the illumination assembly of FIG. 8.

FIG. 10 is a perspective view of an illuminated sign assembly according to an embodiment of the invention.

FIGS. 11A and 11B are schematic illustrations of a sign for use with an illumination assembly according to an embodiment of the invention.

FIG. 12 is a perspective view of an illumination assembly according to a fifth embodiment of the invention.

### DESCRIPTION OF THE CURRENT EMBODIMENTS

### I. Structure

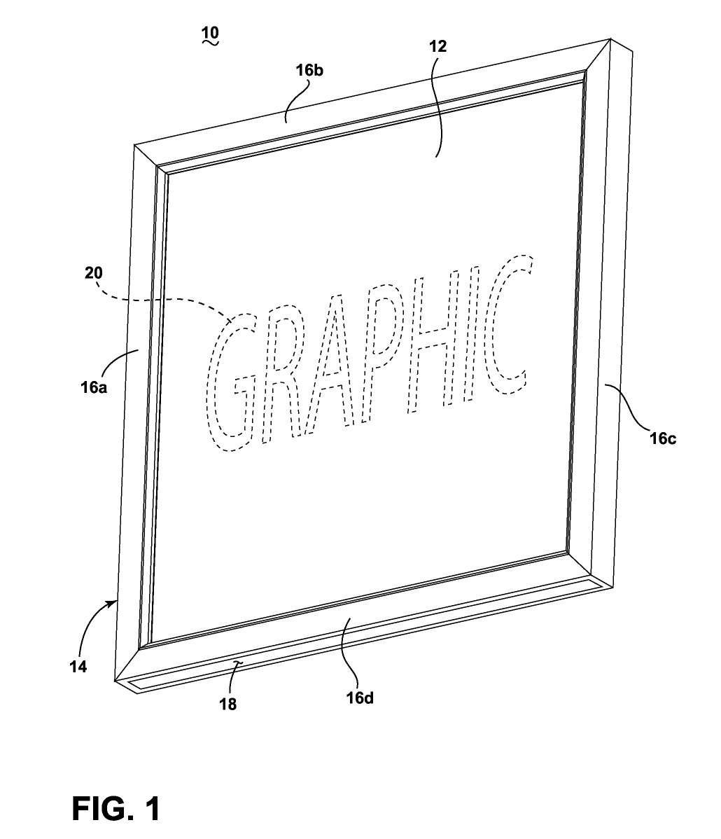

With reference to FIG. 1, an illuminated sign assembly 10 is illustrated in accordance with a first embodiment of the invention. The illuminated sign assembly 10 can include a sign 12 and a frame 14 at least partially encompassing a periphery of the sign 12. The frame 14 can include first, second, third, and fourth legs 16a-d, respectively. At least one of the legs 16d can include an aperture 18. The sign 12 can be provided with any desired graphic 20, non-limiting examples of which include text, images, and combinations thereof. While the illuminated sign assembly 10 is illustrated as having a rectangular shape, it is understood that the assembly 10 can have any desired geometric shape without deviating from the scope of the invention.

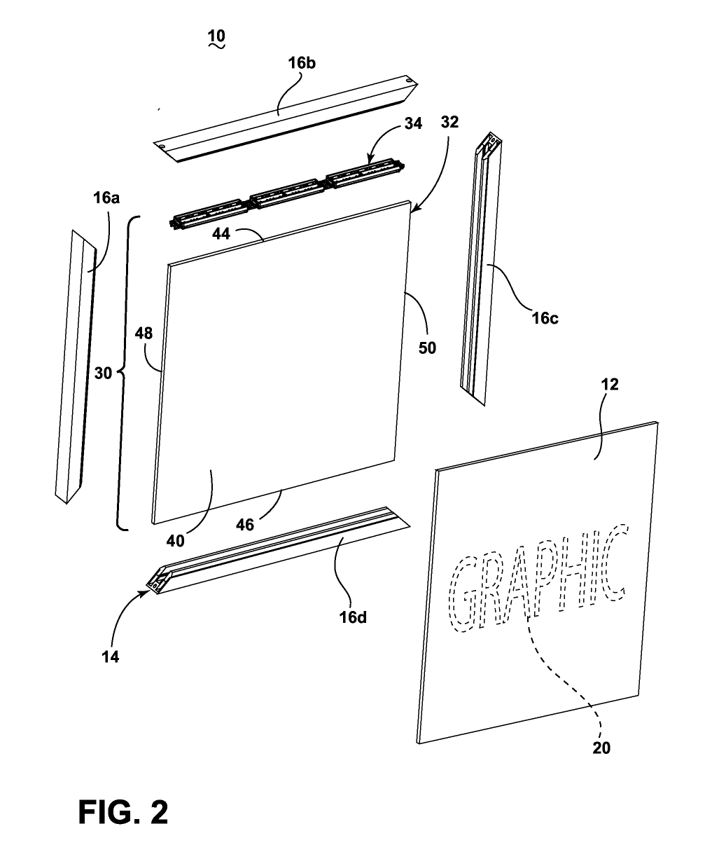

Referring now to FIG. 2, the illuminated sign assembly 10 can include an illumination assembly 30 having a light guide or pipe 32 and a light engine 34. The sign 12 can be in the form of a separate panel having the graphic 20 adhered, etched, printed, painted, and/or engraved thereon. The sign 12 and frame 14 can be configured such that the sign 12 is held in place relative to the light pipe 32 by the frame 14. Alternatively, the sign 12 can be held in place using one or more mechanical fasteners (not shown). In addition to framing the assembly 10 and optionally holding the sign 12 in place relative to the light pipe 32, the frame 14 can also provide additional features, such as acting as a reflector and/or a heat sink for the light engine.

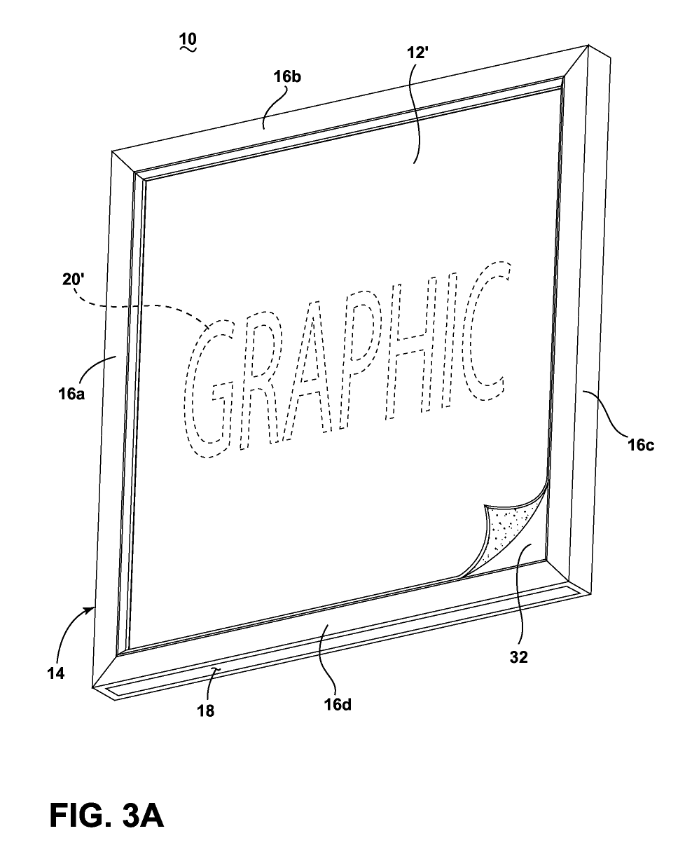

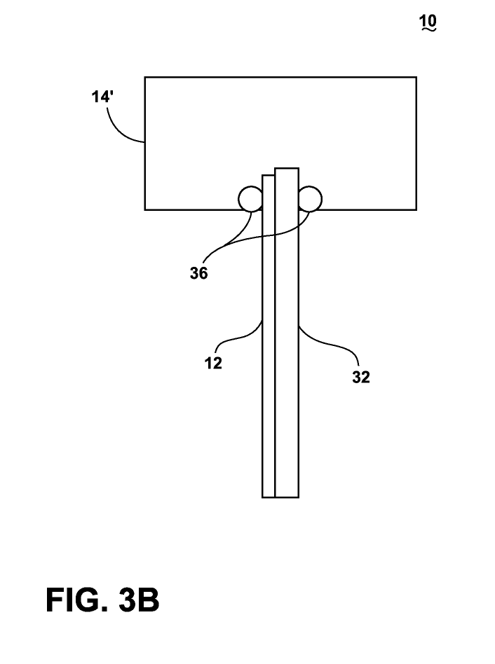

FIG. 3A illustrates a second embodiment in which the sign 12′ is in the form of an adhesive sheet having the graphic 20′ provided thereon that can be applied to the light pipe 32. The sign 12′ can be adhered to the light pipe 32 through the use of an adhesive provided on one or both of the mating surfaces of the sign 12′ and the light pipe 32. Alternatively, the sign 12′ can be held in place electrostatically or through a separate mechanical fastening system. FIG. 3B illustrates a third embodiment in which the frame 14′ is configured to hold the sign 12 in place mechanically through a seal 36, such as an O-ring, that can be provided on one or both sides of the light pipe 32. The frame 14′ can apply pressure to the sign 12 through the seal 36 to maintain the sign 12 in position against the light pipe 32.

Referring again to FIG. 2, the light pipe 32 can include opposing first and second surfaces 40 and 42, opposing first and second edge portions 44 and 46, and opposing third and fourth edge portions 48 and 50. The light pipe 32 can be configured such that at least a portion of the first edge portion 44 includes a light inlet for receiving light emitted from the light engine 34. The light pipe 32 can further be configured such that at least a portion of the first and/or second surfaces 40 and 42 include a light outlet to extract light, or to permit light to exit, from the light pipe 32. The second edge portion 46 can also be configured to include a light outlet to extract light from, or to permit light to exit, the light pipe 32 in addition to the light that is extracted through the light outlet provided in the first and/or second surfaces 40 and 42. A lens (not shown) may be cut, molded, or otherwise formed in the light inlet provided in the first edge portion 44. The light outlets provided in the first and second surfaces 40, 42 and the second edge portion 46 are integral with the light pipe portion 32. Specifically, the light outlets are optical aberrations in or on the surface of the light pipe portion 32. The optical aberrations may be etched, painted, engraved, embedded and/or adhered in or on the surface of the surface of the light pipe portion 23 to form the light outlets. The optical aberrations can be provided in patterns, non-limiting examples of which include dot patterns of offset rows, hatched circles, hatched boxes, lattice structures, chevron shapes, and lines of varying depth. Other optical aberration patterns and configurations will be known to those skilled in the art.

This specification consistently uses the term “light pipe” to refer to the portion 32. The term “light guide” could be used interchangeably with “light pipe”. Light pipe in this specification is intended to include any device designed to transport light from a light source to a location at some distance from the light source with minimal, or at least modest, loss. Light is transmitted through a light pipe by means of internal reflection.

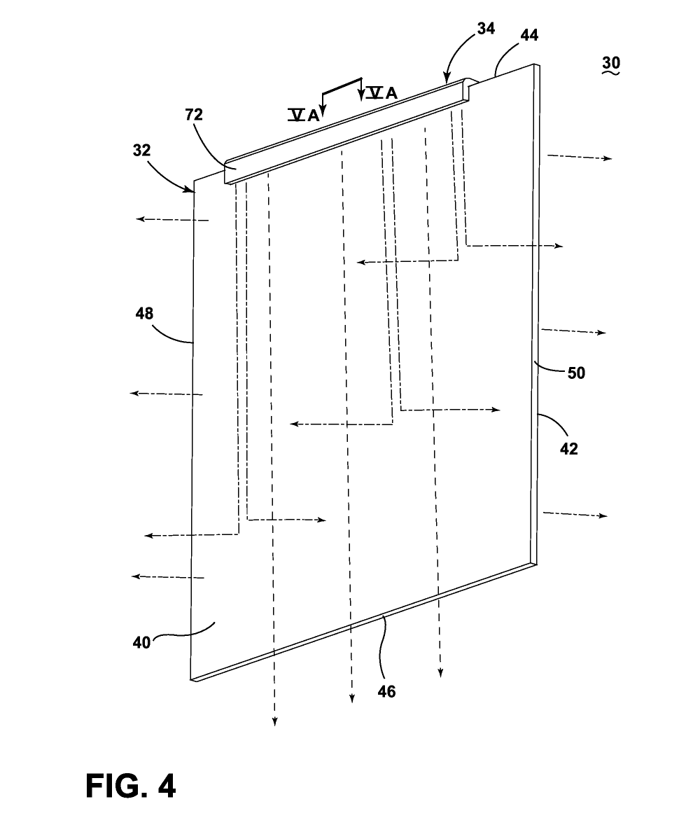

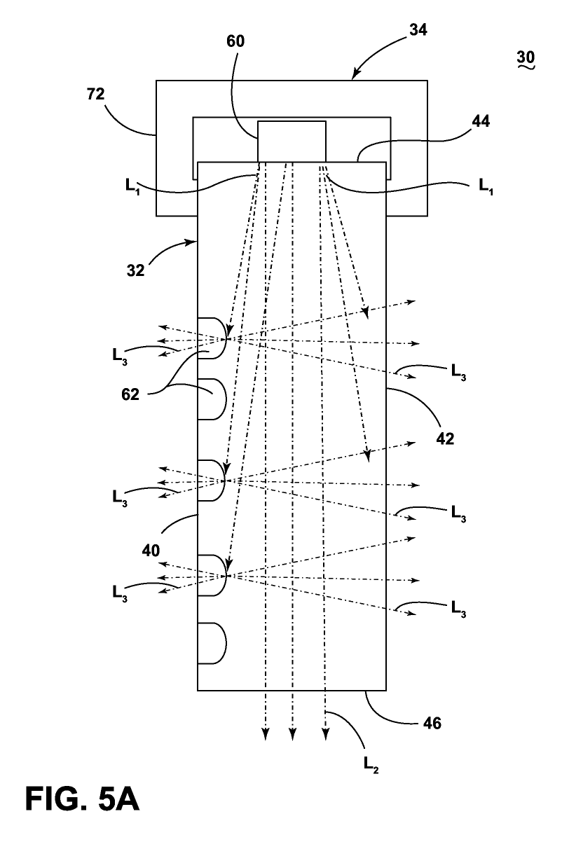

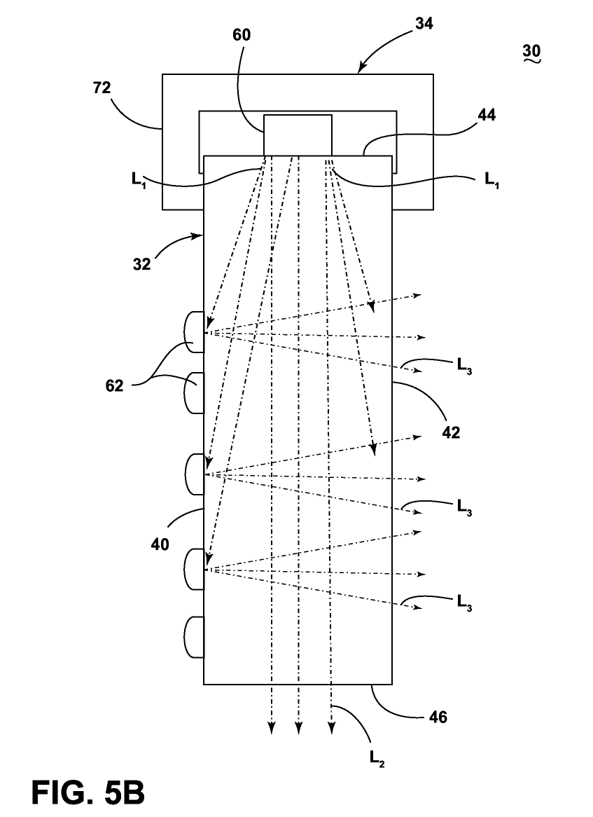

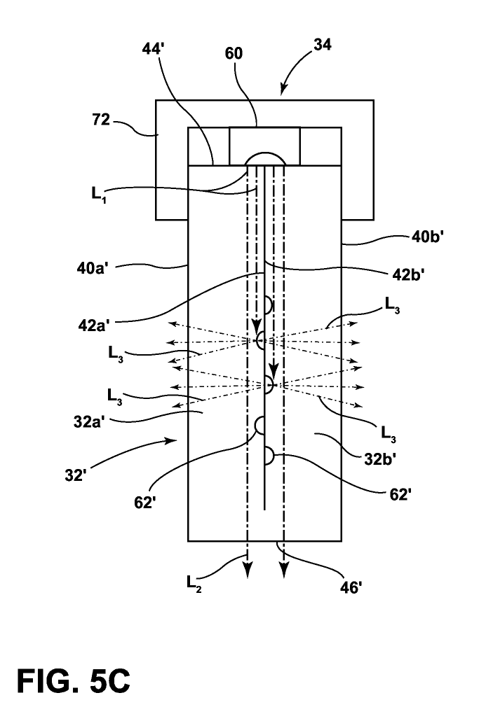

FIGS. 4 and 5A-C are schematic representations of the illumination assembly 30. The light rays are provided to illustrate some of the transmission of light through the light pipe 32. These light rays are provided for illustrative purposes only for the purposes of discussion and should not be interpreted as a representation of the actual transmission of light through the light pipe 32 or all of the emitted and extracted light.

Referring now to FIG. 4, when assembled, the light engine 34 is provided on the first edge portion 44 such that light emitted from the light engine 34 is directed into the light pipe 32 through the light inlet provided in the first edge portion 44. The light pipe 32 can be configured such that at least a portion of the light emitted by the light engine 34 is extracted through the light outlets provided in the first and/or second surfaces 40 and 42 in addition to extracting light through a light outlet formed in at least one of the edge portions 46, 48, or 50.

In an exemplary embodiment, the light pipe 32 is configured to extract light emitted by the light engine 34 through the first and second surfaces 40 and 42 and through the edge portion opposite the edge portion forming the light inlet through which the light from the light engine 34 enters the light pipe 34. In the embodiment of FIG. 4, the light engine 34 is provided on the first edge portion 44 and light is emitted through the first and second surfaces 40 and 42 and the second edge portion 46. In another example, the light pipe 32 can be configured to emit light through only the first surface 40 and the second edge portion 46. In another embodiment, the light pipe 32 can be configured to emit light through one or both of the first and second surfaces 40 and 42, the edge portion 44, 46, 48, 50 opposite the edge portion 44, 46, 48, 50 forming the light inlet and at least one additional edge portion 44, 46, 48, 50. For example, the light pipe 32 can be provided on the first edge portion 44 and light emitted into the light inlet provided therein can be extracted through the first surface 40, the second edge portion 46, and at least one additional edge portion 48 and/or 50.

Referring now to the exemplary embodiment illustrated in FIGS. 5A and 5B, the first edge portion 44 of the light pipe 32 includes a light inlet for receiving light emitted from the light engine 34 provided on the first edge portion 44. The light engine 34 can include at least one light source 60 for emitting light into the light inlet in the first edge portion 44. The light pipe 32 can be configured such that at least a portion of the light L1 emitted from the light source 60 is emitted from the light pipe 32 through the light outlet provided in the second edge portion 46, illustrated by arrows L2. While the light L2 emitted from the light outlet in the second edge portion 46 is illustrated as traveling uninhibited through the light pipe 32, it will be understood that the light emitted by the light source 60 can also be internally reflected multiple times while continuing to travel toward the light outlet in the second edge portion 46.

With reference to FIG. 5A, at least a portion of the light L1 emitted by the light source 60 is reflected by an optical aberration 62, illustrated as an etching, provided within the light pipe 32 which is configured to extract at least a portion of the light L3 for emission through the light outlet provided in the second surface 42. The etching 62 can be formed using any suitable process, non-limiting examples of which include laser etching, machine etching, chemical etching, or in the mold used in forming the light pipe 32, to provide the desired surface geometry for reflecting and/or refracting light to extract light from the light pipe 32 through the light outlets provided in the first and second surfaces 40, 42. As illustrated in FIG. 5A, etching of the light pipe 32 provides bidirectional light extraction with the refracted/reflected light exiting the light pipe 32 through the light outlets in both the first and second surfaces 40, 42. The etching 62 can be configured to extract the desired amount of light for emission through the light outlets in the first and second surfaces 40, 42. While not illustrated in FIG. 5A, the second surface 42 can also include bidirectional optical aberrations to extract a portion of the emitted light L1 for emission through the first and second surfaces 40, 42 in a manner similar to that described above for the portion of light L3 extracted by the optical aberrations 62 provided with the first surface 40.

The optical aberrations 62 can also be configured for uni-directional extraction of light from the light pipe 32. As illustrated in FIG. 5B, the optical aberrations 62 can be provided on the first surface 40 to extract light in a single direction, toward the light outlet in the second surface 42. Non-limiting examples of optical aberrations 62 that can provide uni-directional light extraction include non-transparent paint that is pad printed, screen printed, or ink jet printed on the light pipe 32. While not illustrated in FIG. 5B, the second surface 42 can also include uni-directional aberrations to extract a portion of the emitted light L1 for emission through the first surface 40 in a manner similar to that described for the portion of light L3 emitted through the second surface 42.

Non-limiting examples of optical aberration 62 include dots, lines, hatched circles, hatched boxes, lattice structures, other geometric shapes, such as chevrons, and combinations thereof. The shape, pattern, density, location, and depth of the optical aberration 62 can be selected to extract the desired portion of the light L1 emitted from the light source 60 for emission through the first and/or second surfaces 40, 42.

While the illumination assembly 30 is illustrated as having a single light engine 34 which provides light for extraction through at least one of the first and/or second surfaces 40, 42 and at least one of the edge portions 44, 46, 48, 50, it is within the scope of the invention that the illumination assembly 30 be provided with additional light engines 34 on more than one of the edge portions 44, 46, 48, 50 for emitting light into the light pipe 32 depending on the construction of the illumination assembly 30 and the intended use.

FIG. 5C illustrates an alternative light pipe 32′ that can be used with the illumination assembly 30 in a manner similar to that described above with respect to FIG. 5A. The light pipe 32′ can be formed from two individual light pipes 32a′ and 32b′ that are positioned back-to-back such that the second surface 42a′ of the first light pipe 32a′ is aligned with and abutting the second surface 42b′. The confronting second surfaces 42a′ and 42b′ can include optical aberrations 62′ to reflect at least a portion of the light L1 emitted by the light source 60 to extract at least a portion of the light L3′ for emission through the light outlet provided in the first surfaces 40a′ and 40b′. Including the optical aberrations 62′ toward the middle of the light pipe 32′ instead of near an outer surface of the light pipe 32′, in this embodiment the outer, first surfaces 40a′ and 40b′, can facilitate balancing the amount of light extracted between a front and a rear side of the illumination assembly 30 and reduce visibility of the individual aberrations 62′. In some scenarios, the optical aberrations used to extract light may be visible to a viewer as bright spots and locating the optical aberrations 62′ away from the outer surface and toward the middle of the light pipe 32′ may decrease the likelihood of visible bright spots in the illumination assembly 30. In addition, locating the optical aberrations 62′ away from the outer surface of the light pipe 32′ can provide protection from debris and contamination. Alternatively, rather than the light pipe 32′ being formed from two individual light pipes 32a′ and 32b′, the light pipe 32′ can be a single light pipe having optical aberrations provided near the center of the light pipe. In one example, an internal laser etching process can be used to form optical aberrations near the center of the light pipe.

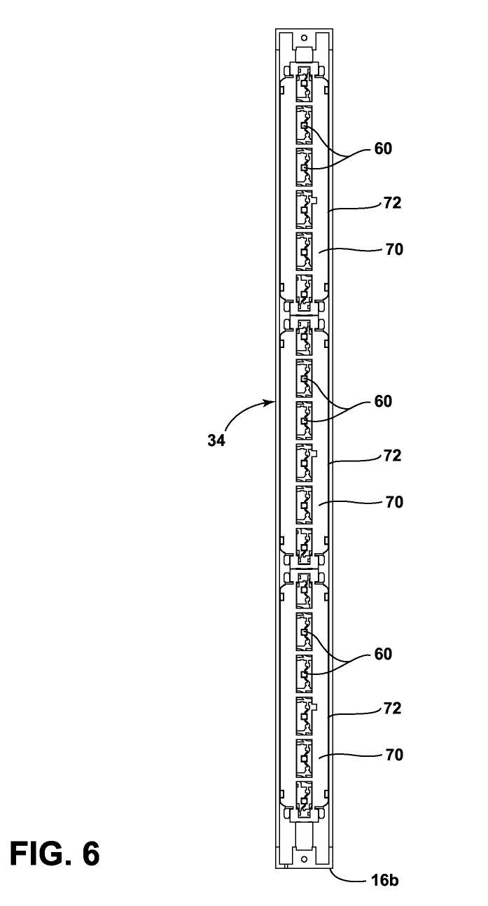

Referring now to FIG. 6, the light engine 34 can include at least one light source 60, which in the present embodiment is in the form of a light emitting diode (LED). The light engine 34 can include multiple LEDs provided in a row generally corresponding to the length of the light inlet in the first edge portion 44. The number, spacing, voltage, current, intensity, and color of the LEDs 60 can be selected depending on the configuration of the illumination assembly 30 and the intended use. As illustrated in FIG. 6, multiple LEDs 60 can be provided as part of a light engine unit 70 and multiple light engine units 70 can be coupled together to form the light engine 34. The light engine units 70 can be configured to share a common electrical circuit such that all of the units 70 of the light engine 34 can be powered through a single electrical connection. Alternatively, the light engine 34 can be a single unit having multiple LEDs.

The light engine 34 can optionally include a light engine frame 72 that is configured to snap on to the light pipe 32 through an interference fit. Alternatively, the light engine 34 can be held in place relative to the light pipe 32 by adhesive or mechanical fasteners, such as clamps or screws. In addition to or as an alternative to the light engine frame 72, the light engine 34 can be held in place by the frame 14 of the sign assembly 10. In yet another example, the light engine 34 can be in the form of multiple LEDs provided in a flexible strip. In still another example, the light engine 34 can include one or more LEDs configured to emit light into the light pipe 32 and one or more LEDs configured to emit light in a different direction, such as away from light pipe 32.

### II. Operation

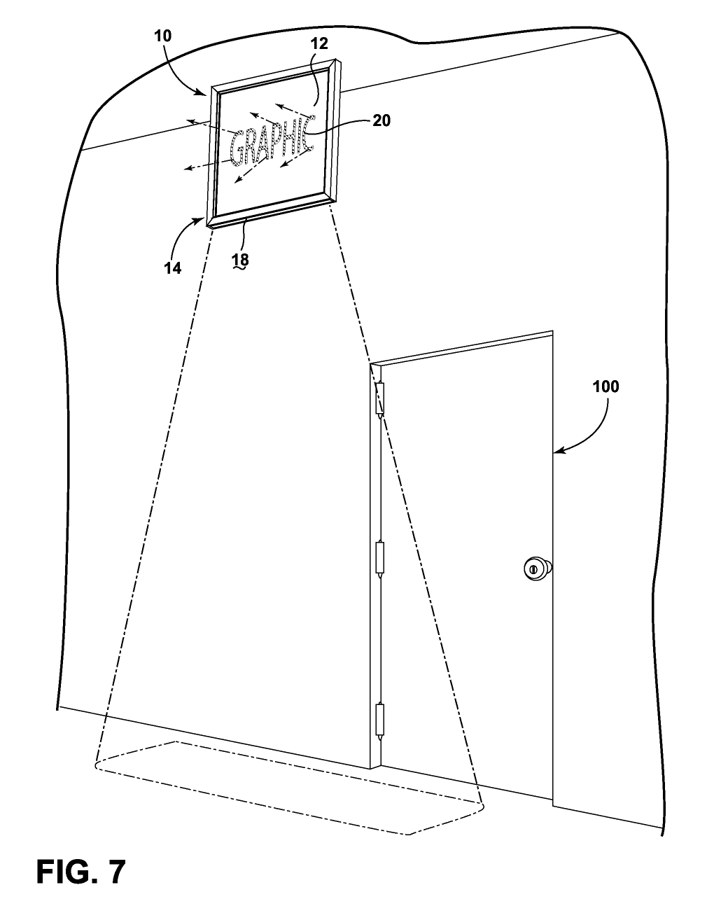

FIG. 7 illustrates the illumination assembly 30 in use in the context of an illuminated sign assembly 10 for use at a building exit 100. As discussed above with respect to FIGS. 4 and 5A-C, the illumination assembly 30 can be configured to extract a portion of the light emitted by the light engine 34 through the light outlet in the first and/or second faces 40, 42 and another portion of the light can be extracted for emission through the light outlet second edge portion 46. The portion of the light extracted through the light outlet in the first and/or second faces 40, 42 provides backlighting for the sign 12 that is provided adjacent the first and/or second faces 40, 42. The portion of the light extracted through the light outlet in the second edge portion 46 is emitted through the aperture 18 provided in the frame 14 for illuminating the environment adjacent the illuminated sign assembly 10, which in the example of FIG. 7 includes downlighting the area adjacent the building exit 100. In this manner, the illuminated sign assembly 10 can be provided with an illumination assembly 30 having a single light engine 34 that provides both a backlighting element and an environmental lighting element (also referred to as area lighting or downlighting, when the area being illuminated is below the light source).

The illumination assembly described herein can be used to optimize light usage compared to more traditional constructions. Typically, when it is desired to provide both backlighting for a sign and environmental lighting, multiple light systems are used: one light system for backlighting and one light system for environmental lighting. This type of construction can require multiple mounting components and electromechanical connections for each lighting system, which can increase assembly, production and/or maintenance costs over time. Electromechanical connections can fail, particularly in environments with elevated heat and/or moisture. The illumination assembly described herein includes a single light engine for providing both backlighting and environmental lighting, thus simplifying the number of components involved and decreasing the number of electromechanical connections involved to a single connection. Decreasing the number of components and electromechanical connections can decrease the number of possible failures and simplify maintenance and replacement of parts, which can save time and increase cost efficiency.

The illumination assembly described herein can also increase energy efficiency by decreasing the amount of wasted light. In the typical construction in which separate lighting systems are used for backlighting and environmental lighting, some of the light from each light system is wasted (i.e. not utilized for a defined purpose). For example, light used for backlighting is often absorbed or lost in parts of the system opposite the light source. The illumination assembly described herein utilizes light that is often wasted in traditional backlighting systems and re-purposes that light for use in environmental lighting. In applications where a power grid is not available or power is not easily accessible, alternative forms of energy, such as a battery and/or solar panel, are used to provide power to operate the lighting systems. Utilizing a single light engine for backlighting and environmental lighting, rather than two separate lighting systems, can provide more efficient use of power and light, which is beneficial in situations in which the system is not connected with the power grid.

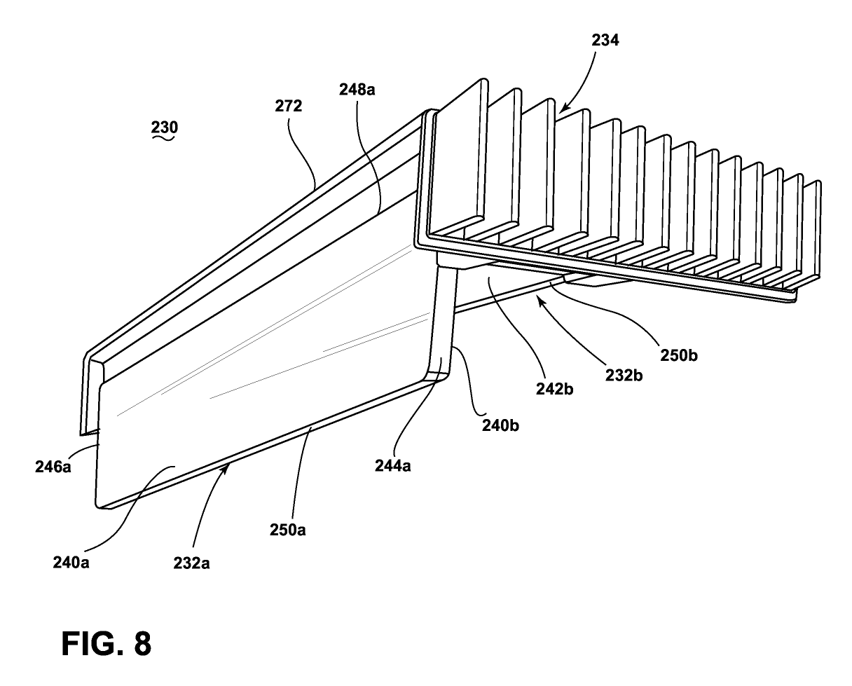

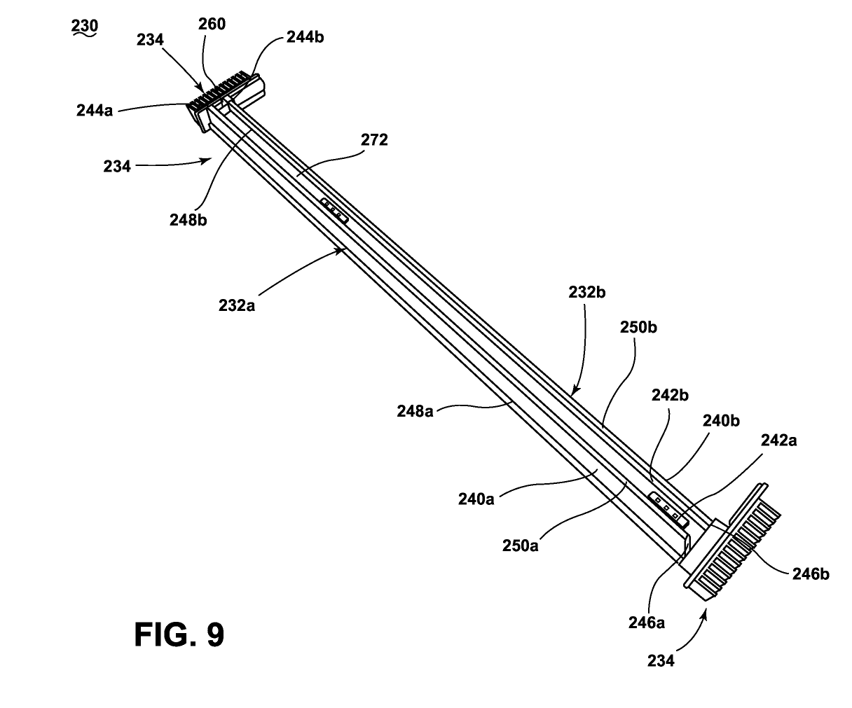

FIGS. 8 and 9 illustrate an illumination assembly 230 that is similar to the illumination assembly 30 of FIGS. 2-6 except for the use of two light pipes 232a and 232b instead of a single light pipe 32. Therefore, elements of the illumination assembly 230 similar to those of the illumination assembly 30 are labeled with the prefix 200.

Still referring to FIGS. 8 and 9, the illumination assembly 230 includes a first light pipe 232a generally aligned with, but spaced from, a second light pipe 232b. Each of the first and second light pipes 232a, 232b can include a first, exterior facing surface 240a, 240b and a second, interior facing surface 242a, 242b, opposing first and second edge portions 244a, 246a and 244b, 246b and opposing third and fourth edge portions 248a, 250a and 248b, 250b. The first and second light pipes 232a, 232b can be configured such that at least a portion of the first edge portion 244a, 244b and optionally at least a portion of the second edge portion 246a, 246b include a light inlet for receiving light emitted from the light engine 234. At least a portion of the first, exterior facing surfaces 240a, 240b, the second interior facing surfaces 242a, 242b and/or the fourth edge portions 250a, 250b can include a light outlet to extract light, or to permit light to exit, from the light pipes 232a, 232b.

The illumination assembly 230 can include at least one light engine 234 located adjacent at least one of the first or second edge portions 244a, 244b or 246a, 246b for emitting light into the light pipes 232a, b. In the embodiment illustrated in FIGS. 8 and 9, a light engine 234 is provided at each end of the illumination assembly 230; one light engine 234 adjacent the first edge portions 244a, 244b and a second light engine 234 adjacent the second edge portions 246a, 246b. The light engine 234 can include one or more light sources 260, which in the present embodiment is in the form of an LED. The number, spacing, voltage, current, intensity, and color of the LEDs 260 in each of the light engines 234 can be selected depending on the configuration of the illumination assembly 230 and the intended use.

The light emitted from each of the first and second light pipes 232a, 232b can be the same or differ in at least one characteristic, such as intensity and/or wavelength. One or more of the light sources in the light engine 234 can emit light of a specific wavelength interval within the visible light spectrum to provide colored illumination. In one example, one of the light pipes 232a, 232b can be illuminated with a colored light source while the other of the light pipes 232a, 232b is illuminated with a white light source. Alternatively, a white light source can be used and the inlet provided in the first edge portion 244a, 244b and/or the second edge portion 246a, 246b can include filters to provide the light pipes 232a, 232b with light of a specific wavelength interval to provide the desired visible color of light. In another example, the outlet provided in the first, exterior facing surfaces 240a, 240b, the second interior facing surfaces 242a, 242b and/or the fourth edge portions 250a, 250b can include filters such that the light exiting the light pipes 232a, 232b has desired color.

The illumination assembly 230 can also include an assembly frame 272 to which the components of the illumination assembly 230 can be mounted. The assembly frame 272 can be coupled with the first and second light pipes 232a, 232b and the light using any mechanical and/or non-mechanical fastener, non-limiting examples of which include clamps, retaining clips, adhesives, and an interference or friction fit. The assembly frame 272 can extend at least a portion of the length of the first and second light pipes 232a, 232b or the entire length, as illustrated. Alternatively, the assembly frame 272 can be provided only at the ends of the first and second light pipes 232a, 232a. An optional additional frame (not shown), similar to the frame 14 of FIG. 1, can be provided to fully or partially encompass the illumination assembly 230. In addition to mounting the components of the illumination assembly 230, the assembly frame 272 can also act as a heat sink and dissipater. In one example, the assembly frame 272 can be made from extruded aluminum.

Similar to that which is discussed above with respect to the illumination assembly 30 of FIGS. 4 and 5A, each light pipe 232a, 232b can be configured to extract a portion of the light emitted by the light engine 234 through the light outlets provided in the first, exterior facing surfaces 240a, 240b and the fourth edge portions 250a, 250b. The light extracted through the light outlets in the first, exterior facing surfaces 240a, 240b and the fourth edge portions 250a, 250b can be used to provide a combination of backlighting and area lighting adjacent the illumination assembly 230.

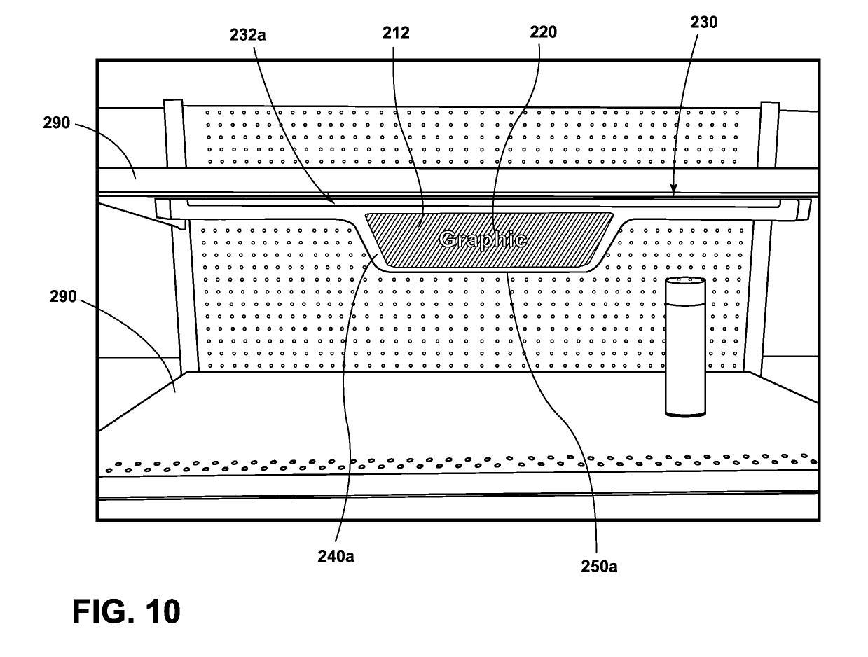

FIG. 10 illustrates the illumination assembly 230 in use in the context of an illuminated sign assembly 210 for use with shelving 290. The illuminated sign assembly 210 can include the illumination assembly 230 and a sign 212 having a graphic 220, similar to that described above with respect to the sign 12, 12′ of FIGS. 1 and 3A-B. The portion of the light emitted by the light engines 234 into the first light pipe 232a and extracted through the first, exterior facing surface 240a of the first light pipe 232a provides backlighting for the graphic 220. The portion of the light emitted by the light engines 234 and extracted through the fourth edge portion 250a can provide area lighting (also referred to as downlighting) to illuminate the area below the illuminated sign assembly 210. The portion of the light emitted by the light engines 234 into the second light pipe 232b and extracted through the first, exterior facing surface 240b can provide plane lighting and the fourth edge portion 250b of the second light pipe 232b can provide downlighting, both of which provide area lighting to illuminate the area below and behind the illuminated sign assembly 210. In this manner, the illumination assembly 230 can be used to provide illumination for advertising and informational purposes by backlighting the graphic 220 as well as providing illumination to the area on the shelf 290 to facilitate viewing the shelf 290 and any items stored thereon.

The configuration of the sign 212 and graphic 220 can take any of a number of forms. In the example illustrated in FIG. 10, the sign 212 can be separate from the light pipe 232a in the form of a panel or sheet that is maintained adjacent the light pipe 232a by a mechanical fastener and/or a non-mechanical fastener. The sign 212 can include cut-outs or areas of increased and/or decreased transparency that form the graphic 220 which are backlit by the portion of the light extracted through the first, exterior facing surface 240a. The mounting of the sign 212 can be permanent or can be configured such that the sign 212 is replaceable with a different sign. For example, the sign 212 can be in the form of peel-and-stick sheet which adheres to the first surface 240a through electrostatic interactions. In another example, the illumination assembly 230 can be provided with a track and/or mechanical fasteners, such as reusable clamps or clips, to mount the sign 212 in position relative to the light pipe 232a. Alternatively, the sign 212 can be mounted to a frame or to an adjacent surface that suspends the sign 212 in position relative to the light pipe 232. For example, mechanical fasteners can be provided on the edge of the shelf 290 just above the illumination assembly 230 that can mount the sign 212 to the shelf 290 adjacent the light pipe 232a.

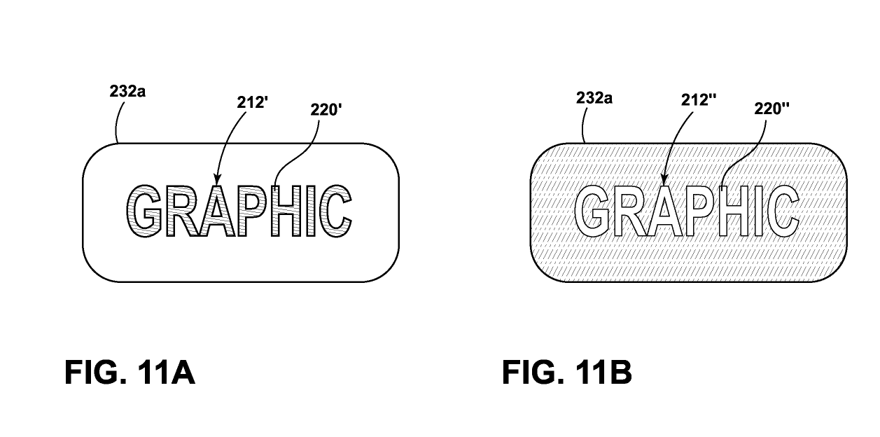

Alternatively, rather than providing the sign 212 as an individual component, the sign 212 and graphic 220 can be integrally formed with the light pipe 232a. For example, as illustrated in FIG. 11A, the graphic 220′ can be engraved into the first, exterior facing surface 240a, such as through a chemical or mechanical etching process. The engraved graphic 220′ can be provided with a characteristic, such as a texture, color, and/or transparency, which is different than the surrounding light pipe material to alter the light emitted from the first, exterior facing surface 240a to provide a visual contrast between the graphic 220′ and the surrounding light pipe 232a when illuminated. Alternatively, or in addition to the engraved graphic 220′, the graphic 220′ can be formed by applying a finish, such as a paint, a dye, a light frequency filter, photo-reactive inks or dyes, or a mirror finish, to the first, exterior facing surface 240a to form the shape of the graphic 220′. FIG. 11B illustrates another alternative for integrally forming the graphic 220″ with the light pipe 232a. A finish, such as a paint, a dye, photo-reactive inks or dyes, or a mirror finish, can be applied to the first, exterior facing surface 240a to outline the graphic 220″.

While the sign 212 is discussed in the context of the first, exterior facing surface 240a, it will be understood that the first, exterior facing surface 240b can also include a sign 212, that is the same or different than the sign 212 provided with the first, exterior facing surface 240a, in a manner similar to that described above with respect to the first, exterior facing surface 240a.

The illumination assembly 230 can be mounted to the shelf 290 in any suitable manner. For example, the illuminated sign assembly 230 can be mounted to a front portion or a top or bottom surface of the shelf 290 using one or more mechanical fasteners, non-limiting examples of which include hooks, clamps, ties, and screws. In another example, the shelf 290 can be provided with a track or housing configured to receive the illumination assembly 230 and hold the illumination assembly 230 in place relative to the shelf 290. The illumination assembly 230 can be mounted directly to the shelf 290 or the illumination assembly 230 can be provided with a suitable frame that is itself mounted to the shelf 290.

One or more illuminated assemblies 230 can be mounted in series depending on the size of the assembly 230 and the area to be illuminated. The light engines 234 of adjacent illuminated assemblies 230 can be configured to electrically connect such that connecting one illumination assembly 230 with a power source provides power to all of the connected illuminated assemblies 230.

In addition, while the illumination assembly 230 is described in the context of parallel, rectangular shaped light pipes 232a, 232b, it will be understood the light pipes 232a, 232b can be of any suitable geometric shape depending on the intended use of the illumination assembly 230 and that more than two light pipes can be utilized without deviating from the scope of the invention. It will also be understood that the light pipes used in the illumination assembly 230 can be oriented at angle with respect to one another depending on the intended use of the illumination assembly 230.

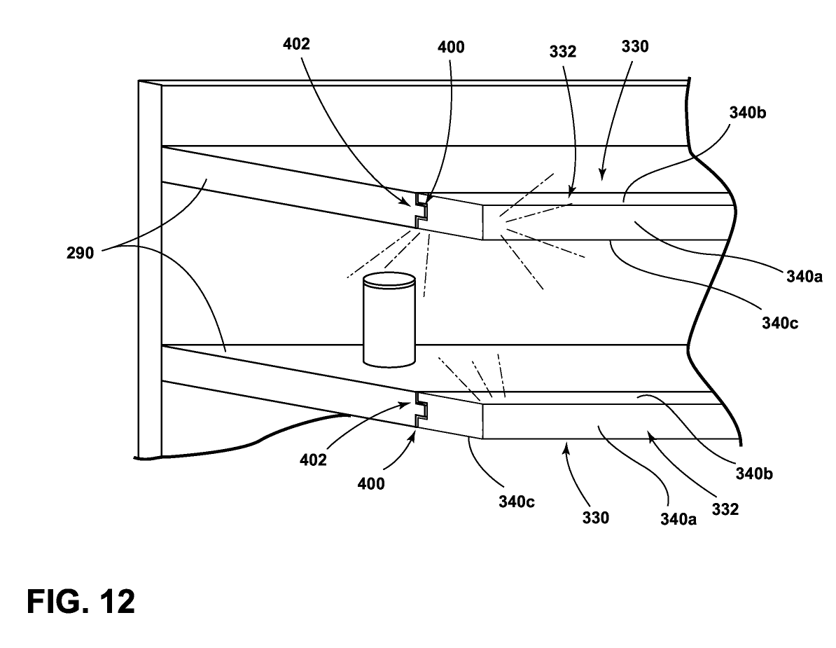

Referring now to FIG. 12, an illumination assembly 330 is illustrated that is similar to the illumination assembly 230 of FIGS. 8-9 except for the manner in which the light pipe 332 is mounted to the shelf 290. The illumination assembly 330 also shares several features similar to those of the illumination assembly 30 of FIGS. 2-6. Therefore, elements of the illumination assembly 330 similar to those of the illumination assemblies 30 and 230 are labeled with the prefix 300.

The illumination assembly 330 includes at least one light pipe 332 that includes a first exterior facing surface 340a, a second exterior facing surface 340b, and a third exterior facing surface 340c, each of which includes a light outlet to extract light, or permit light to exit, from the light pipe 332 in a manner similar to that discussed above for the light pipes 32 and 232 of FIGS. 1-2 and 8-9, respectively. The light pipe 332 can be a single light pipe, as illustrated, or multiple light pipes can be used to form one or more of the first, second, and third exterior facing surfaces 340a, 340b, 340c.

The illumination assembly 330 can also include an assembly mounting element 400 that can be integrally formed with the light pipe 332 or part of a separate element or frame to which the light pipe 332 is mounted. The assembly mounting element 400 can be configured to mate with a corresponding shelf mounting element 402 provided on the shelf 290 to mount the illumination assembly 330 to the shelf 290. As illustrated in FIG. 12, the assembly mounting element 400 and the shelf mounting element 402 couple through a tongue-and-groove connection, which may optionally include additional fasteners (not shown), such as screws or pins, to secure the illumination assembly 330 in place. The assembly mounting element 400 and the shelf mounting element 402 can be coupled together through any suitable interlocking or mating design. In another example, the illumination assembly 330 or the shelf 290 can include resilient snap-fit features which deform to allow the illumination assembly 330 to be slid into place and then flex back into their original position to engage the illumination assembly 330 or the shelf 290 to mount the illumination assembly. In another example, at least one of the assembly mounting element 400 and shelf mounting element 402 may include apertures that receive mechanical fasteners, such as screws, for securing the illumination assembly 330 to the shelf 290.

As illustrated in FIG. 12, the illumination assembly 330 can optionally be configured such that when it is mounted to the shelf 290, the illumination assembly 330 is generally aligned with the shelf 290 and forms an extension of said shelf 290. The illumination assembly 330 can be configured such that the second exterior facing surface 340b is generally flush with the adjacent shelf surface. Mounting the illumination assembly 330 in this manner can increase the aesthetics of the design by visually integrating the illumination assembly 330 with the shelf 290 and also minimizes obstruction of the area on the shelf 290 by the illumination assembly 330.

While the illumination assemblies 230, 330 are discussed in the context of mounting to a shelf, it will be understood that it is within the scope of the invention for the illumination assemblies 230, 330 to be used in other environments and mounted to other structures, non-limiting examples of which include walls, ceilings, floors, tables, chairs, and doors.

As illustrated in FIG. 12, the first exterior facing surface 340a can be used for backlighting a sign in a manner similar to that described above for the illumination assemblies 30 and 230 of FIGS. 1-2 and 8-9. The second exterior facing surface 340b and/or the third exterior facing surface 340c can be configured to provide area lighting for the area on the shelf 290 above and/or below the illumination assembly 330. In one example, both the second exterior facing surface 340b and the third exterior facing surface 340c can be configured to provide area lighting. Alternatively, the second exterior facing surface 340b can also be provided with a sign in a manner similar to that described above for the illumination assemblies 30 and 230 of FIGS. 1-2 and 8-9 while the third exterior facing surface 340c is configured to provide downlighting.

The illumination assemblies 230, 330 can address several challenges in the area of product display and advertising. For example, the illumination assemblies 230, 330 described herein can provide area illumination for adjacent shelving to increase visibility of the shelving area and any items stored thereon while also providing backlighting for signage to identify the area and draw attention to the area in a single illuminaire The area illumination can facilitate viewing of the items themselves as well as any labels on the items and attract individuals to the items, compared to shelving which is unlit or poorly illuminated, and provide more uniform illumination with minimal glare or shadowing. The backlighting can draw the attention of individuals to the shelving and items stored thereon compared to signage that is not illuminated. When one of the light pipes in the illumination assemblies 230, 330 is illuminated with colored light, the illumination assemblies 230, 330 can provide three features in a single illuminaire: area lighting, plane lighting, and colored lighting.

The illumination assemblies 230, 330 can provide versatility in backlighting and area lighting. For example, as discussed above, the signs and/or light pipes can be configured such that the signs used with the light pipe can be exchanged with different signs depending on the items located on the shelving. In addition, the light pipes and/or the light sources can be interchangeable to provide different illumination characteristics, such as different colors of light or different intensities of extracted light. The light pipes can also be interchangeable to provide different exterior facing surface shapes for receiving signs for backlighting. The illumination assemblies 230, 330 can also be configured to provide backlighting for signs on multiple sides of the illumination assemblies 230, 330. For example, the illumination assemblies 230, 330 can be configured to backlight signs provided on front and rear sides or front and top sides of the illumination assemblies 230, 330, depending on the configuration of the shelving.

### III. Conclusion

The above description is that of current embodiments of the invention. Various alterations and changes can be made without departing from the spirit and broader aspects of the invention as defined in the appended claims, which are to be interpreted in accordance with the principles of patent law including the doctrine of equivalents. To the extent not already described, the different features and structures of the various embodiments of the illumination assemblies 30, 230, 330 and the illuminated sign assemblies 10, 210 may be used in combination with each other as desired. That one feature may not be illustrated in all of the embodiments is not meant to be construed that it cannot be, but is done for brevity of description. Thus, the various features of the different embodiments of the illumination assemblies 30, 230, 330 and the illuminated sign assemblies 10, 210 may be mixed and matched as desired to form new embodiments, whether or not the new embodiments are expressly disclosed.

This disclosure should not be interpreted as an exhaustive description of all embodiments of the invention or to limit the scope of the claims to the specific elements illustrated or described in connection with these embodiments. For example, and without limitation, any individual element of the described invention may be replaced by one or more alternative elements that provide substantially similar functionality or otherwise provide adequate operation. This includes, for example, presently known alternative elements, such as those that might be currently known to one skilled in the art, and alternative elements that may be developed in the future, such as those that one skilled in the art might, upon development, recognize as an alternative.

The invention is not limited to the details of operation or to the details of construction and the arrangement of the components set forth in the above description or illustrated in the drawings. The invention may be implemented in various other embodiments and practiced or carried out in alternative ways not expressly disclosed herein.

The phraseology and terminology used herein are for the purpose of description and should not be regarded as limiting. The use of “including” and “comprising” and variations thereof is meant to encompass the items listed thereafter and equivalents thereof as well as additional items and equivalents thereof. Further, enumeration may be used in the description of various embodiments. Unless otherwise expressly stated, the use of enumeration should not be construed as limiting the invention to any specific order or number of components. Nor should the use of enumeration be construed as excluding from the scope of the invention any additional steps or components that might be combined with or into the enumerated steps or components.

The disclosed embodiment includes a plurality of features that are described in concert and that might cooperatively provide a collection of benefits. The present invention is not limited to only those embodiments that include all of these features or that provide all of the stated benefits.

Any reference to claim elements in the singular, for example, using the articles “a,” “an,” “the” or “said,” is not to be construed as limiting the element to the singular.

Directional terms, such as “front,” “back,” “vertical,” “horizontal,” “top,” “bottom,” “upper,” “lower,” “inner,” “inwardly,” “outer” and “outwardly,” are used to assist in describing the invention based on the orientation of the embodiments shown in the illustrations. The use of directional terms should not be interpreted to limit the invention to any specific orientation.

The embodiments of the invention in which an exclusive property or privilege is claimed are defined as follows:

1. An illumination assembly comprising:
a light pipe including a first edge portion including a light inlet, a first surface including a first light outlet, and a second edge portion including a second light outlet; and
a light engine attached to the first edge portion and including a light source adapted to direct light into the light inlet, whereby light subsequently exits the light pipe through the first light outlet and the second light outlet.

2. The illumination assembly of claim 1 wherein the light pipe further includes a second surface including a third light outlet, whereby light additionally exits the light pipe through the third light outlet.

3. The illumination assembly of claim 1 wherein the light engine is fitted over the first edge portion.

4. The illumination assembly of claim 1 wherein the light pipe includes an optical aberration to direct a portion of the light through the first light outlet and a portion of the light through the second light outlet.

5. The illumination assembly of claim 4 wherein the optical aberration is provided to alter a density, a location, or a direction of the light, or combinations thereof.

6. The illumination assembly of claim 1 wherein the light source comprises at least one LED.

7. The illumination assembly of claim 1, further comprising a frame extending about at least a portion of a periphery of the light pipe.

8. The illumination assembly of claim 7 wherein the frame extends about the entire periphery of the light pipe, and the frame further includes an aperture adjacent the second light outlet.

9. The illumination assembly of claim 7 wherein the frame comprises a heat sink, a reflector, or combinations thereof.

10. The illumination assembly of claim 1, further comprising a sign having a graphic, wherein the light exiting the first light outlet backlights the graphic.

11. An illumination assembly comprising:
a light pipe having a first surface and at least first and second edge portions; and
a light engine on the first edge portion of the light pipe and having a light source configured to emit light into the first edge portion of the light pipe;
wherein the light pipe is configured such that a direction of travel of at least a first portion of the light emitted into the first edge portion is altered to extract the light through the first surface of the light pipe and at least a second portion of the light emitted into the first edge portion exits the light pipe through the second edge portion.

12. The illumination assembly of claim 11 wherein the first surface includes an optical aberration to alter the direction of travel of the first portion of the light.

13. The illumination assembly of claim 12 wherein the optical aberration is provided to alter a density, a location, or a direction of the extraction of the light, or combinations thereof.

14. The illumination assembly of claim 11 wherein the light pipe further includes a second surface, and wherein the light pipe is configured to extract at least a third portion of the light through the second surface.

15. The illumination assembly of claim 11 wherein the light source comprises at least one LED.

16. The illumination assembly of claim 11, further comprising a frame extending about at least a portion of a periphery of the light pipe.

17. The illumination assembly of claim 11, further comprising a sign having a graphic thereon, wherein the first portion of the light extracted through the first surface backlights the graphic.

18. An illuminated sign assembly comprising:
a first sign comprising a graphic;
a light pipe having a first surface aligned with the first sign and at least first and second edges; and
a light engine on the first edge of the light pipe and having a light source configured to emit light into the first edge of the light pipe;
wherein the light pipe is configured to alter a direction of travel of at least a first portion of the light emitted by the light engine to backlight the graphic and a second portion of the light is emitted through the second edge to illuminate an area adjacent the second edge.

19. The illuminated sign assembly of claim 18 wherein the light pipe includes an optical aberration to alter the direction of travel of the first portion of the light.

20. The illuminated sign assembly of claim 18, further comprising a second sign comprising a graphic and wherein the light pipe further includes a second surface, aligned with the second sign, the light pipe configured to extract a third portion of the light through the second surface to backlight the graphic on the second sign.

21. The illuminated sign assembly of claim 18 wherein the light source comprises at least one LED.

22. The illuminated sign assembly of claim 18 wherein the first sign comprises a panel having the graphic at least one of adhered, etched, printed, painted, or engraved thereon or combinations thereof.

23. The illuminated sign assembly of claim 18 wherein the first sign is integrally formed with the light pipe.

24. The illuminated sign assembly of claim 23 wherein the graphic is etched, painted, mirrored or combinations thereof onto a surface of the light pipe to form the first sign.

25. An illumination assembly comprising:
a first light pipe including a first edge portion including a light inlet, a first surface including a first light outlet, and a second edge portion including a second light outlet;
a second light pipe including a third edge portion including a light inlet, a second surface including a third light outlet, and a fourth edge portion including a fourth light outlet; and
at least one light engine attached to the first edge portion of the first light pipe and the third edge portion of the second light pipe and including at least one light source adapted to direct light into the respective light inlets, whereby light subsequently exits the first light pipe through the first and second light outlets and exits the second light pipe through the third and fourth light outlets.

26. The illumination assembly of claim 25 wherein the first and second light pipe are parallel and spaced apart.

27. The illumination assembly of claim 25 wherein the first light pipe further includes a third surface including a fifth light outlet and the second light pipe further includes a fourth surface including a sixth light outlet, whereby light additionally exits the first and second light pipes through the fifth and sixth light outlets, respectively.

28. The illumination assembly of claim 25 wherein the at least one light engine is fitted over the first edge portion of the first light pipe and the third edge portion of the second light pipe.

29. The illumination assembly of claim 25 wherein the first and second light pipes include an optical aberration to direct a portion of the light through the first and second light outlets of the first light pipe and to direct a portion of the light through the third and fourth light outlets of the second light pipe.

30. The illumination assembly of claim 29 wherein the optical aberration is provided to alter a density, a location, or a direction of the light, or combinations thereof.

31. The illumination assembly of claim 25 wherein the light source comprises at least one LED.

32. The illumination assembly of claim 25, further comprising a frame extending about at least a portion of a periphery of the first and second light pipes.

33. The illumination assembly of claim 25 wherein the frame comprises a heat sink, a reflector, or combinations thereof.

34. The illumination assembly of claim 25, further comprising at least one sign having a graphic, wherein the light exiting the first light outlet of the first light pipe and/or the light exiting the third light outlet of the second light pipe backlights the graphic.

35. The illumination assembly of claim 34 wherein the light exiting the first light outlet of the first light pipe backlights the graphic and the light exiting the first light pipe through the second light outlet and the light exiting the second light pipe through the third and fourth light outlets provides area lighting.

36. The illumination assembly of claim 34 wherein the at least one sign comprises a panel having the graphic at least one of adhered, etched, printed, painted, or engraved thereon or combinations thereof.

37. The illumination assembly of claim 34 wherein the at least one sign is integrally formed with at least one of the first or second light pipes.

38. The illumination assembly of claim 37 wherein the graphic is etched, painted, mirrored or combinations thereof onto a surface of the first and/or second light pipe to form the at least one sign.

39. The illumination assembly of claim 25 wherein at least one of the at least one light engines, the first light pipe, the second light pipe, or combinations thereof is configured such that at least one of the first light pipe or the second light pipe emits colored light.

40. The illumination assembly of claim 25 further comprising a first mounting element that mates with a corresponding second mounting element on a surface for securing the illumination assembly to the surface.

41. The illumination assembly of claim 40 wherein the first and second mounting elements mate through at least one of a tongue-and-groove fit, a snap fit, aligned apertures and mechanical fasteners, or combinations thereof.

42. The illumination assembly of claim 40 wherein the surface comprises a shelf and the illumination assembly is configured such that when the illumination assembly is secured to the shelf by the first and second mounting elements, at least one surface of the first or second light pipes is flush with an adjacent surface of the shelf.
